(19) United States
(12) Patent Application Publication
(10) Pub. No.: US 2024/0370770 A1
(43) Pub. Date: Nov. 7, 2024

(54) SYSTEMS AND METHODS FOR OBJECT REFERENCE PREDICTION

(71) Applicant: JPMORGAN CHASE BANK, N.A., New York, NY (US)

(72) Inventor: Haythem OUNAISSA, Didcot (GB)

(21) Appl. No.: 18/313,209

(22) Filed: May 5, 2023

(51) Int. Cl. G06N 20/00

(52) U.S. Cl. CPC G06N 20/00

(57) ABSTRACT

In some aspects, the techniques described herein relate to a method including: receiving, as input to a machine learning engine, a processing operation identifier, and an initial data object reference, wherein the processing operation identifier identifies a processing operation; generating, as output from the machine learning engine, a set of data object references, wherein the set of data object references are predicted as required input to the processing operation by the machine learning engine; executing a batch retrieval process, wherein the batch retrieval process retrieves a set of data objects that corresponds to the set of data object references from a datastore; loading the set of data objects in a cache; and executing the processing operation using the predicted set of data objects loaded in the cache.

### BACKGROUND

### 1. Field of the Invention

Aspects generally relate to systems and methods for object reference prediction.

### 2. Description of the Related Art

Often, programmatic processes require loading a significant number of data objects from a datastore. Objects may be modeled/structured, e.g., in a hierarchical or graph structure. Conventionally, however, data object hierarchies and dependencies require data to be loaded from a datastore and processed before related data necessary for a process can be determined. Moreover, object dependencies within a graph, and the graph structure, itself, are not fixed. This dynamic nature leads to many connections to, and queries of, a datastore as object relations are discovered (and rediscovered in an evolving graph structure) and the related objects are retrieved from the datastore and loaded for processing. But such repeated connections and queries results in sub-optimal performance and increased latency. The ability to retrieve all required data objects for a given operation in a batch retrieval operation would increase efficiency but the required data objects must first be determined.

### SUMMARY

In some aspects, the techniques described herein relate to a method including: receiving, as input to a machine learning engine, a processing operation identifier, and an initial data object reference, wherein the processing operation identifier identifies a processing operation; generating, as output from the machine learning engine, a set of data object references, wherein the set of data object references are predicted as required input to the processing operation by the machine learning engine; executing a batch retrieval process, wherein the batch retrieval process retrieves a set of data objects that corresponds to the set of data object references from a datastore; loading the set of data objects in a cache; and executing the processing operation using the set of data objects loaded in the cache.

In some aspects, the techniques described herein relate to a method, wherein the initial data object reference is a key value, and wherein the datastore is a key-value pair datastore.

In some aspects, the techniques described herein relate to a method, wherein the processing operation identifier identifies a computer application.

In some aspects, the techniques described herein relate to a method, including: saving a training data set, wherein the training data set includes a set of data object references from a historical execution of the processing operation.

In some aspects, the techniques described herein relate to a method, wherein the training data set includes the processing operation identifier and the initial data object reference.

In some aspects, the techniques described herein relate to a method, including: processing the training data set with a machine learning algorithm.

In some aspects, the techniques described herein relate to a method, including: generating, based on processing the training data set with a machine learning algorithm, a machine learning model, wherein the machine learning model is executed by the machine learning engine to predict the set of data object references.

In some aspects, the techniques described herein relate to a system including at least one computer including a processor, wherein the at least one computer is configured to: receive, as input to a machine learning engine, a processing operation identifier, and an initial data object reference, wherein the processing operation identifier identifies a processing operation; generate, as output from the machine learning engine, a set of data object references, wherein the set of data object references are predicted as required input to the processing operation by the machine learning engine; execute a batch retrieval process, wherein the batch retrieval process retrieves a set of data objects that corresponds to the set of data object references from a datastore; load the set of data objects in a cache; and execute the processing operation using the set of data objects loaded in the cache.

In some aspects, the techniques described herein relate to a system, wherein the initial data object reference is a key value, and wherein the datastore is a key-value pair datastore.

In some aspects, the techniques described herein relate to a system, wherein the processing operation identifier identifies a computer application.

In some aspects, the techniques described herein relate to a system, wherein the at least one computer is configured to: save a training data set, wherein the training data set includes a set of data object references from a historical execution of the processing operation.

In some aspects, the techniques described herein relate to a system, wherein the training data set includes the processing operation identifier and the initial data object reference.

In some aspects, the techniques described herein relate to a system, wherein the at least one computer is configured to: process the training data set with a machine learning algorithm.

In some aspects, the techniques described herein relate to a system, wherein the at least one computer is configured to: generate, based on processing the training data set with a machine learning algorithm, a machine learning model, wherein the machine learning model is executed by the machine learning engine to predict the set of data object references.

In some aspects, the techniques described herein relate to a non-transitory computer readable storage medium, including instructions stored thereon, which instructions, when read and executed by one or more computer processors, cause the one or more computer processors to perform steps including: receiving, as input to a machine learning engine, a processing operation identifier, and an initial data object reference, wherein the processing operation identifier identifies a processing operation; generating, as output from the machine learning engine, a set of data object references, wherein the set of data object references are predicted as required input to the processing operation by the machine learning engine; executing a batch retrieval process, wherein the batch retrieval process retrieves a set of data objects that corresponds to the set of data object references from a datastore; loading the set of data objects in a cache; and executing the processing operation using the set of data objects loaded in the cache.

In some aspects, the techniques described herein relate to a non-transitory computer readable storage medium, wherein the initial data object reference is a key value, and wherein the datastore is a key-value pair datastore.

In some aspects, the techniques described herein relate to a non-transitory computer readable storage medium, wherein the processing operation identifier identifies a computer application.

In some aspects, the techniques described herein relate to a non-transitory computer readable storage medium, including: saving a training data set, wherein the training data set includes a set of data object references from a historical execution of the processing operation, the processing operation identifier, and the initial data object reference.

In some aspects, the techniques described herein relate to a non-transitory computer readable storage medium, including: processing the training data set with a machine learning algorithm.

In some aspects, the techniques described herein relate to a non-transitory computer readable storage medium, including: generating, based on processing the training data set with a machine learning algorithm, a machine learning model, wherein the machine learning model is executed by the machine learning engine to predict the set of data object references.

### BRIEF DESCRIPTION OF THE DRAWINGS

FIG. 1 is a block diagram of a system for object reference prediction, in accordance with aspects.

FIG. 2 is a logical flow for object reference prediction, in accordance with aspects.

FIG. 3 is a block diagram of a computing device for implementing certain aspects of the present disclosure.

### DETAILED DESCRIPTION

Aspects generally relate to systems and methods for object reference prediction.

In accordance with aspects, a machine learning model may predict a number of data objects needed to complete a processing operation. The predicted data objects may then be retrieved from a datastore as a batch retrieval and may be stored in a cache. A processing engine may be in operative communication with the cache and may retrieve the needed data objects from the cache. The cache may be a high-speed memory that allows direct access by a processing engine.

In accordance with aspects, retrieving data objects needed for a processing operation in a batch job reduces overhead related to connection processing and overhead due to Input/Output processing hardware constraints. For instance, a batch retrieval job may only require a single connection to the datastore to retrieve all data objects referenced in the batch job, as opposed to opening and managing a new connection/session to a datastore each time a required data object is determined by a processing operation. This, in turn, may allow much more efficient execution of a processing operation, since retrieving data from a high-speed cache introduces much less latency then reading one object at a time from a datastore.

Some aspects disclosed herein are in the context of financial processing operations, but these aspects are exemplary only, and not meant to be limiting. For instance, the techniques described herein may be applied to a strategic platform for trader risk management. Such a platform may be used for capturing trades, processing trades, confirmation of settlements, reporting to regulators, etc. Aspects may provide analytics to desktop applications that allow traders to make trading decisions, make markets, manage risk, etc. An exemplary platform may include a datastore platform and any number of business platforms, analytical platforms, etc. Each business or analytical platform may include a processing engine that includes logic that requires data objects for processing.

A datastore platform may include any suitable datastore. Exemplary datastores include NoSQL datastores, such as key-value stores, document databases, columnar databases, and graph databases. Exemplary datastores may also include relational databases, data warehouses, data lakes, etc. A processing engine may be configured as a computer application that takes data objects as inputs and generates output based on the data objects. The computer application may include logic that defines a processing operation. The logic may be configured to generate output related to a business goal or objective.

A processing operation may require, as input to the processing operation, information stored in a plurality of data objects that are persisted in a datastore. The processing operation, however, may only have a reference to an initial data object (e.g., a key associated with a binary data object in a key-value store). A data object may refer to business object modeled in, e.g., object oriented-style modeling and that can be instantiated as an in-memory object by an application written in object-oriented programming language. A data object may be nested with various fields, inheritance, and other attributes of object-oriented data object models.

Accordingly, the processing operation may query that datastore to retrieve the data object associated with the initial reference. For instance, a processing operation for pricing a financial instrument may query a key-value store using a known initial key associated with a data object related to the financial instrument. That is, a processing operation may use an initial key value as a lookup parameter to obtain information about a financial instrument stored in a corresponding first data object that is associated with the initial key. The data object returned by the initial query, however, may reference a second object in the datastore (e.g., via the second object's associated key). Consequently, the processing operation may have to execute a second query of the datastore using the key of the referenced second object to obtain the information associated with the second data object. This process may continue traversing, e.g., a data hierarchy or graph until all relevant and/or necessary values are retrieved from the datastore.

In accordance with aspects, a given processing operation (such as transaction pricing, financial instrument pricing, or instrument risk evaluation) will generally use similar data to obtain desired output results over relatively short periods of time. That is, in a transaction pricing operation executed in a pricing application or a risk evaluation operation executed within a risk management application, similar data will be used from day-to-day to produce output results. Accordingly, data prediction models may be trained using historical data loads. Data retrieved in the recent past for completing a particular processing operation may be included in a historical data load.

In accordance with aspects, if a certain number and pattern of keys were retrieved from a key-value datastore for a given operation over the past several days, weeks, months, etc., then these numbers and patterns may reasonably be expected to be similar to a number and pattern of key value pairs that will be needed to perform the given operation in the present, or immediate or near future. This is due to the mathematical model of the processing operation being the same over time. Accordingly, even though the information housed in relevant data objects may change, the number and pattern of object references (e.g., keys) needed to retrieve the data models may remain relatively constant.

In accordance with aspects, an object reference prediction machine learning (ML) algorithm may be trained using historical data loads for a given processing operation. A trained ML model may then take a reference to an initial data object as input. A ML model may further take an identifier for a particular processing operation as input. Based on the reference to the initial data object and the identifier associated with the processing operation to be executed, the ML model may generate a prediction of a number of data model references that the identified processing operation is likely to read during execution. Moreover, a ML model may predict, for each predicted reference, a probability that the predicted reference will be required by the associated program for data extraction. The predicted data object references may then be extracted from the datastore in a batch extraction/retrieval and may be loaded to a cache from which the identified processing operation may read the objects as needed.

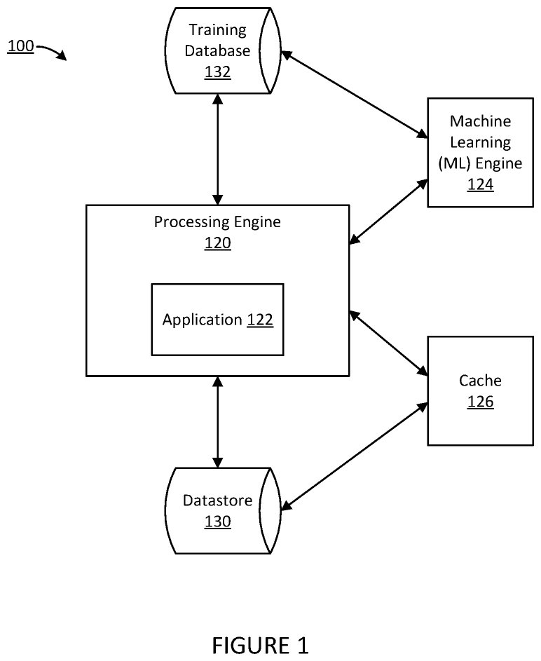

FIG. 1 is a block diagram of a system for object reference prediction, in accordance with aspects. System 100 includes processing engine 120, application 122, machine learning (ML) engine 124, and cache 126. System 100 further includes datastore 130 and training database 132.

In accordance with aspects, processing engine 120 may be comprised of one or more computers, each including at least on processor and including or in operative communication with a memory. Processing engine 120 may execute application 122, which may be a computer application as discussed further herein. Application 122 may be a processing operation that may take one or more inputs and generate or compute one or more outputs. Application 122 may be, for instance, a transaction pricing or risk evaluation application that generates prices or risk profiles for financial instruments. Application 122 may take, as input, a data object. The data object may be retrieved from datastore 130 using a data object reference that is known to application 122.

Datastore 130 may be any suitable datastore. For instance, datastore 130 may be a NoSQL key-value pair datastore, a relational database, etc. Datastore 130 may be structured as a data hierarchy, a graph, or any suitable structure. The data object reference known to application 122 may be any suitable data object reference (or combination of data object references) that can be used to locate and extract a corresponding data object from a datastore. For instance, the data object reference may be a key value that corresponds to a data object (e.g., a binary data object) and is stored in a key-value pair datastore or a primary key value from a relational data base, etc. The data object reference may be “known” to application 122 as a hard-coded reference or may be provided in any suitable manner (e.g., by a user initiating processing of application 122 through an interface).

In accordance with aspects, processing engine 120 may execute application 122 and may, as part of the processing operation, use the known data object reference in a query to retrieve the corresponding data object from datastore 130. The retrieved data object may reference further related data objects using the related data objects' own object references (e.g., such as a corresponding key value). Application 122 may retrieve data objects referenced by the initial data object and may continue to connect to and retrieve additional data objects as such objects are referenced in retrieved data objects until all data objects needed to complete the processing operation defined by application 122 have been retrieved from datastore 130. In this way, the processing operation may traverse the data structure of datastore 130 (e.g., a data hierarchy or graph) as new data object references are discovered until all relevant and/or necessary values are retrieved from the datastore.

In accordance with aspects, processing engine 120 may be configured to store the initial known data object reference and all subsequent downstream data object references in training database 132 as a training data set. Additionally, processing engine 120 may be configured to store an identifier of application 122 (e.g., an identifier of a particular processing operation) in training database 132 and associate (e.g., via a relation) the application/operation identifier with the initial known data object reference and the training data set. This training data, including an application/operation identifier, an initial data object reference, and all downstream data object references, may be exposed as training data to a machine learning algorithm that is executed by ML engine 124. The ML algorithm of ML engine 124 may fit the training data to a ML model and the resultant ML model may predict what data object references may be needed to complete the processing operation associated with the initial data object and the input application/operation identifier included in the training data. The ML model may predict a set of object references and associated probabilities (i.e., an associated likelihood that a predicted object will be used by the application).

FIG. 4 is a block diagram showing exemplary inputs to and output from a machine learning engine. ML Engine 405 receives an operation identifier and one or more initial data objects as input and generates predicted data object references as output.

With additional reference to FIG. 1 and in accordance with aspects, after training, a ML model produced and executed by ML engine 124 may predict a number of data object references that will be required to execute a particular processing operation. For instance, at the outset of a processing operation, ML engine 124 may be provided with an application/operation identifier and an initial data object reference as input and may generate as output a number of data object references whose corresponding data objects will be needed to complete the processing operation associated with the provided application/operation identifier. ML engine 124 may return the output prediction to processing engine 120 and processing engine 120 may generate a batch retrieval process that retrieves all of the data objects referenced by the data object references predicted by ML engine 124 in a single batch process and loads all of the data object retrieved by the batch process into cache 126.

Cache 126 may store the retrieved data objects for use by application 122. Cache 126 may be a high-speed memory (such as an L2 cache or other random access, and/or volatile memory) that allows direct access by processing engine 120. In some aspects, cache 126 may be an in-process cache, while other aspects may utilize an external cache. In accordance with aspects, processing engine 120 and application 122 may complete the processing operation with reduced latency by using the data objects stored in cache 126 instead of retrieving the data objects from datastore 130 as they are reference by various other data objects downstream from the initial known data object.

In accordance with aspects, a reference prediction ML model may not predict every object reference that a corresponding application requires for processing. In some aspects, an ML model may predict references that are not required (i.e., are superfluous). In aspects where a ML model fails to predict a required reference or erroneously predicts an object reference, the application may connect to the data store and retrieve the missing references, the prediction failures may be logged, and a corresponding training data set may be updated to reflect the missing references. The updated training data may then be exposed to the ML model thereby fitting the corrected data to the model through a training feedback loop in order to enhance the model's accuracy.

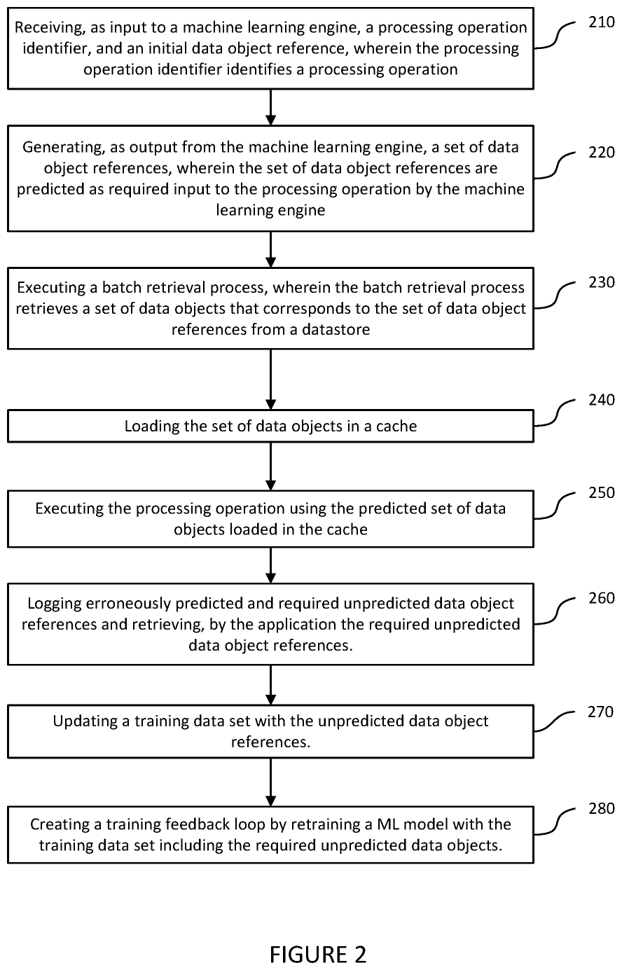

FIG. 2 is a logical flow for object reference prediction, in accordance with aspects.

Step 210 includes receiving, as input to a machine learning engine, a processing operation identifier, and an initial data object reference, wherein the processing operation identifier identifies a processing operation.

Step 220 includes generating, as output from the machine learning engine, a set of data object references, wherein the set of data object references are predicted as required input to the processing operation by the machine learning engine.

Step 230 includes executing a batch retrieval process, wherein the batch retrieval process retrieves a set of data objects that corresponds to the set of data object references from a datastore.

Step 240 includes loading the set of data objects in a cache.

Step 250 includes executing the processing operation using the predicted set of data objects loaded in the cache.

Step 260 includes logging erroneously predicted and required unpredicted data object references and retrieving, by the application the required unpredicted data object references.

Step 270 includes updating a training data set with the unpredicted data object references.

Step 280 includes creating a training feedback loop by retraining a ML model with the training data set including the required unpredicted data objects.

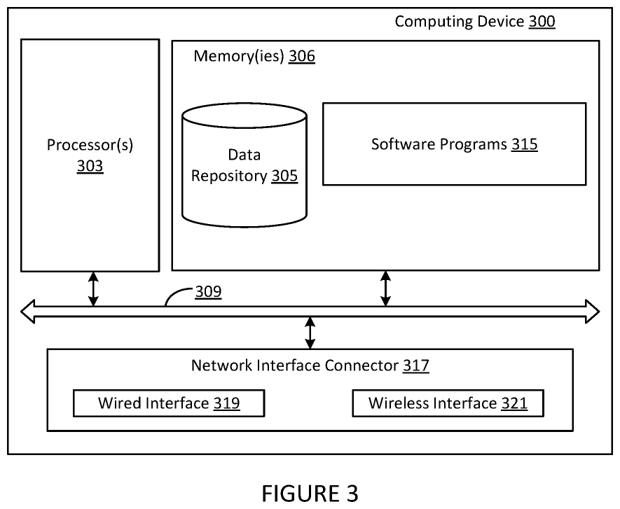

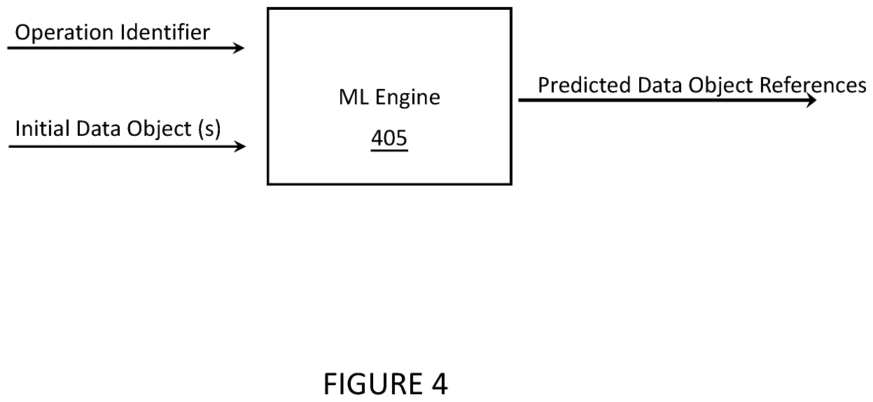

FIG. 3 is a block diagram of a computing device for implementing certain aspects of the present disclosure. FIG. 3 depicts exemplary computing device 300. Computing device 300 may represent hardware that executes the logic that drives the various system components described herein. For example, system components such as a processing engine, a machine learning engine, a cache, various database engines and database servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which can be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” etc. These may be a general-purpose computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized as a program, software program, or simply software. In one aspect, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various aspects of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some aspects of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many aspects and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary aspects, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such aspects, adaptations, variations, modifications, or equivalent arrangements.

1. A method comprising:
receiving, as input to a machine learning engine, a processing operation identifier, and an initial data object reference, wherein the processing operation identifier identifies a processing operation;
generating, as output from the machine learning engine, a set of data object references, wherein the set of data object references are predicted as required input to the processing operation by the machine learning engine;
executing a batch retrieval process, wherein the batch retrieval process retrieves a set of data objects that corresponds to the set of data object references from a datastore;
loading the set of data objects in a cache; and
executing the processing operation using the set of data objects loaded in the cache.

2. The method of claim 1, wherein the initial data object reference is a key value, and wherein the datastore is a key-value pair datastore.

3. The method of claim 1, wherein the processing operation identifier identifies a computer application.

4. The method of claim 1, comprising:
saving a training data set, wherein the training data set comprises a set of data object references from a historical execution of the processing operation.

5. The method of claim 4, wherein the training data set includes the processing operation identifier and the initial data object reference.

6. The method of claim 5, comprising:
processing the training data set with a machine learning algorithm.

7. The method of claim 6, comprising:
generating, based on processing the training data set with a machine learning algorithm, a machine learning model, wherein the machine learning model is executed by the machine learning engine to predict the set of data object references.

8. A system comprising at least one computer including a processor, wherein the at least one computer is configured to:
receive, as input to a machine learning engine, a processing operation identifier, and an initial data object reference, wherein the processing operation identifier identifies a processing operation;
generate, as output from the machine learning engine, a set of data object references, wherein the set of data object references are predicted as required input to the processing operation by the machine learning engine;
execute a batch retrieval process, wherein the batch retrieval process retrieves a set of data objects that corresponds to the set of data object references from a datastore;
load the set of data objects in a cache; and
execute the processing operation using the set of data objects loaded in the cache.

9. The system of claim 8, wherein the initial data object reference is a key value, and wherein the datastore is a key-value pair datastore.

10. The system of claim 8, wherein the processing operation identifier identifies a computer application.

11. The system of claim 8, wherein the at least one computer is configured to:
save a training data set, wherein the training data set comprises a set of data object references from a historical execution of the processing operation.

12. The system of claim 11, wherein the training data set includes the processing operation identifier and the initial data object reference.

13. The system of claim 12, wherein the at least one computer is configured to:
process the training data set with a machine learning algorithm.

14. The system of claim 13, wherein the at least one computer is configured to:
generate, based on processing the training data set with a machine learning algorithm, a machine learning model, wherein the machine learning model is executed by the machine learning engine to predict the set of data object references.

15. A non-transitory computer readable storage medium, including instructions stored thereon, which instructions, when read and executed by one or more computer processors, cause the one or more computer processors to perform steps comprising:
receiving, as input to a machine learning engine, a processing operation identifier, and an initial data object reference, wherein the processing operation identifier identifies a processing operation;
generating, as output from the machine learning engine, a set of data object references, wherein the set of data object references are predicted as required input to the processing operation by the machine learning engine;
executing a batch retrieval process, wherein the batch retrieval process retrieves a set of data objects that corresponds to the set of data object references from a datastore;
loading the set of data objects in a cache; and
executing the processing operation using the set of data objects loaded in the cache.

16. The non-transitory computer readable storage medium of claim 15, wherein the initial data object reference is a key value, and wherein the datastore is a key-value pair datastore.

17. The non-transitory computer readable storage medium of claim 15, wherein the processing operation identifier identifies a computer application.

18. The non-transitory computer readable storage medium of claim 15, comprising:
saving a training data set, wherein the training data set comprises a set of data object references from a historical execution of the processing operation, the processing operation identifier, and the initial data object reference.

19. The non-transitory computer readable storage medium of claim 18, comprising:
processing the training data set with a machine learning algorithm.

20. The non-transitory computer readable storage medium of claim 19, comprising:
generating, based on processing the training data set with a machine learning algorithm, a machine learning model, wherein the machine learning model is executed by the machine learning engine to predict the set of data object references.
